(19) United States
(12) Patent Application Publication
(10) Pub. No.: US 2007/0004425 A1
(43) Pub. Date: Jan. 4, 2007

(54) Network support for mobile terminal presence notification

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/173,413

(22) Filed: Jun. 30, 2005

(51) Int. Cl. H04Q 7/20

(52) U.S. Cl. 455/456.1

(57) ABSTRACT

An apparatus in one example has: a plurality spaces in a predefined three dimensional area; at least one mobile terminal in a wireless telecommunications network; a tracking system structured to track the at least one mobile terminal in the plurality of predefined spaces in the predefined three dimensional area; and a monitor module in the wireless telecommunications network, the monitor module operatively coupled to receive, via the tracking system, a current position of the at least one mobile terminal in the plurality of predefined spaces in the predefined three dimensional area.

### TECHNICAL FIELD

The invention relates generally to telecommunications networks, and more particularly to a telecommunications network that automatically notifies the owner of a building when a mobile terminal is present in an area such as a building or part of a building.

### BACKGROUND

Cellular telephone communications technologies have advanced rapidly in the last decade. A key advance in the development of cellular telephone communications is the advent of digital microcells. Such systems use of a plurality of contiguous cells, each cell with a master site and a plurality of zone sites defining communication zones, which are defined by a plurality of suitably positioned antenna sets within the periphery of the cell. Consequently, each zone has a transmitting and receiving means directionally configured to limit propagation of signals substantially to a zone within the boundaries of the cell.

Microcell network architecture typically covers “deadspots” or high traffic density areas occurring in larger macrocells. For example, one cell structure that may be suitable for high traffic personal communication networks includes a plurality of macrocells. A plurality of microcells is selectively deployed within a macrocell in areas of very high traffic density. The microcell architecture allows an increase in caller handling capacity. A typical macrocell may be 1 km or more in radius. A typical microcell may cover an area of approximately 200 m radius, for example, with each microcell typically having a capacity of handling 8 to 16 callers.

In a typical analog cellular telephone system, a plurality of contiguous cells, each having a different assigned set of transmission frequencies, are arranged with handoff means for maintaining continuous communication with mobile telephones moving from cell to cell. As a mobile unit travels along a path that passes from one cell to another, a handoff occurs which switches the mobile unit from a frequency in the set assigned to the cell it is leaving, to a new frequency in the set assigned to the cell it is entering. The handoff action is controlled by a mobile telephone switching office (MTSO), which receives a handoff command or instruction. The handoff command is typically generated when the signal received from the mobile telephone falls below a pre-selected signal strength thus indicating that the mobile telephone is at the cell boundary.

In an analog system, each cell in a cellular telephone system operates with a different assigned set of transmission frequencies. As a mobile telephone passes from one cell to another, the handoff signal instructs the cell which the mobile telephone is entering to begin transmitting at a frequency which is different from the frequency which was being transmitted by the cell which the mobile telephone was leaving. A similar procedure is followed when the mobile telephone passes into the next contiguous cell. Sets of assigned frequencies are different for adjacent cells, and such sets are not repeated except for cells that are far enough away from each other so that interference problems will not occur. In the case of systems using identification codes, the identification codes are generally not repeated.

A mobile telephone unit typically contains a control unit, a transceiver, and an antenna system. Each cell site typically is provided with a control unit, radio, a power plant, data terminals, and antennas. The MTSO provides coordination for all the cell sites and contains suitable processing and switching means. The MTSO also interfaces with the telephone company zone offices for standard hardwired telephone systems. The communication links between the MTSO and the various cell sites are typically microwave, T carriers, or optical fiber, and carry both voice and control data between the cell sites and the MTSO.

The tracking of various items is well known. One example is the trucking industry, wherein drivers of vehicles periodically communicate with a home office to report the location of the vehicle and the status of the shipment. Similar systems are used for the shipping of mail and other packages, with updates to the location of the package with the carrier, as well as its estimated time of arrival, and other related information. Tracking of vehicles is highly desirable when recovery of a stolen vehicle is attempted.

Tracking of vehicles and shipments may include LORAN and GPS. Both of these systems rely on externally transmitted radio frequency signals to calculate the location of a receiving antenna mounted on the vehicle. In LORAN systems, the calculation is based on the time difference and signals received from multiple transmitters. Because the latitude and longitude of the transmitters are known, the distance from two or more transmitters can be calculated from the time differential between the reception of the plurality of signals.

In the GPS tracking system, transmitters are positioned on orbiting satellites. GPS uses a pseudo-random data stream encoded on each satellites' carrier frequency. The receiver is synchronized with the data stream by matching an identical suedo-random data stream albeit with a time offset. The time offset between the receiver's data stream and the data stream received from the satellite give the distance to that satellite via the speed of light that the radio signal traveled. The receiver then triangulates its position using three or more satellites and by knowing where the satellites are via their ephemeris data. GPS systems have been developed to be extremely accurate in locating and tracking a receiver on the surface of the earth.

Many business campuses, government campuses, and individual buildings need to know the current location of various individuals when they are present in the buildings. This may include, for example, visitors in secured government buildings, doctors in hospitals, students in schools, etc. The traditional method of login/logout using ID badges is not always practical, because, for example, people can “piggyback” on other employees without logging in or out, or a person can login/logout, then change his/her mind by not actually entering/leaving the premises.

Thus there is a need in the prior art for an improved system in which, for example, a telecommunications network may automatically notify the owner of a building when a mobile terminal is present in an area such as a building or part of a building

### SUMMARY

The invention in one implementation encompasses an apparatus. This embodiment of the apparatus may comprise: a plurality of predefined spaces in a predefined three dimensional area; at least one mobile terminal in a wireless telecommunications network; a tracking system structured to track the at least one mobile terminal in the plurality of predefined spaces in the predefined three dimensional area; and a monitor module in the wireless telecommunications network, the monitor module operatively coupled to receive, via the tracking system, a current position of the at least one mobile terminal in the plurality of predefined spaces in the predefined three dimensional area.

The invention in another implementation encompasses an apparatus. This embodiment of the apparatus may comprise: a plurality of predefined spaces in a predefined three dimensional area; at least one mobile terminal having a GPS (Global Positioning System) module; a wireless telecommunications network to which is provided, via the GPS module, a current position of the at least one mobile terminal in the plurality of predefined spaces in the predefined three dimensional area; and a monitor module in the wireless telecommunications network, the monitor module operatively coupled to receive the current position of the at least one mobile terminal in the plurality of predefined spaces in the predefined three dimensional area.

The invention in another implementation encompasses an apparatus. This embodiment of the apparatus may comprise: a plurality of predefined spaces in a predefined three dimensional area; a plurality of microcells in a wireless telecommunications network, a respective microcell in the plurality of microcells corresponding to a respective predefined space in the plurality of predefined spaces; and a monitor module in the wireless telecommunications network, the monitor module operatively coupled to the plurality of microcells for tracking locations of mobile terminals located in the plurality of predefined spaces.

Another implementation of the invention encompasses a method. This embodiment of the method may comprise: defining a plurality of predefined spaces in a predefined three dimensional area; tracking at least one mobile terminal, associated with a telecommunications network, in the plurality of predefined spaces in the predefined three dimensional area; and reporting to a management server, which is associated with the three dimensional area and operatively coupled to the wireless telecommunications network, a current position of the at least one mobile terminal in the plurality of predefined spaces in the predefined three dimensional area.

### DESCRIPTION OF THE DRAWINGS

Features of exemplary implementations of the invention will become apparent from the description, the claims, and the accompanying drawings in which:

FIG. 1 is a representation of one implementation of an apparatus that automatically notifies the owner (or other entities) of a campus when a mobile terminal is present in an area such as a building or part of a building;

FIG. 2 is a representation of another implementation of an apparatus that automatically notifies the owner of a building when a mobile terminal is present in an area such as a building or part of a building;

FIG. 3 is a representation of yet another implementation of an apparatus that automatically notifies the owner of a building when a mobile terminal is present in an area such as a building or part of a building; and

FIG. 4 is a representation of one exemplary flow diagram for automatically notifying the owner of a building when a mobile terminal is present in an area such as a building or part of a building.

### DETAILED DESCRIPTION

One methodology of the present apparatus and method is for the wireless telecommunications network to detect when a mobile terminal enters a building or part of a building. The wireless telecommunications network may provide a building management server, for example, that subscribes to the service, with a current location of the mobile terminal. A plurality of mobile terminals may also be tracked in the building.

Often doctors must be paged repeatedly throughout a hospital without even knowing if the doctor is even present in the hospital. Embodiments of the present apparatus and method may provide for determining if the doctor is in the hospital and even the room or area before paging the doctor, Also the doctor may be paged only in the area where the doctor is currently located thus providing a quieter hospital environment.

Embodiments of the present apparatus and method makes it possible to know if a mobile terminal of a mobile subscriber is in the confines of a building or a part of the building, and even the floor of the building. Other applications may include taking attendance of students as they walk into school, or recording their presence in each class throughout the course of a day. Further applications may include tracking current locations of visitors within business campuses, government offices, etc.

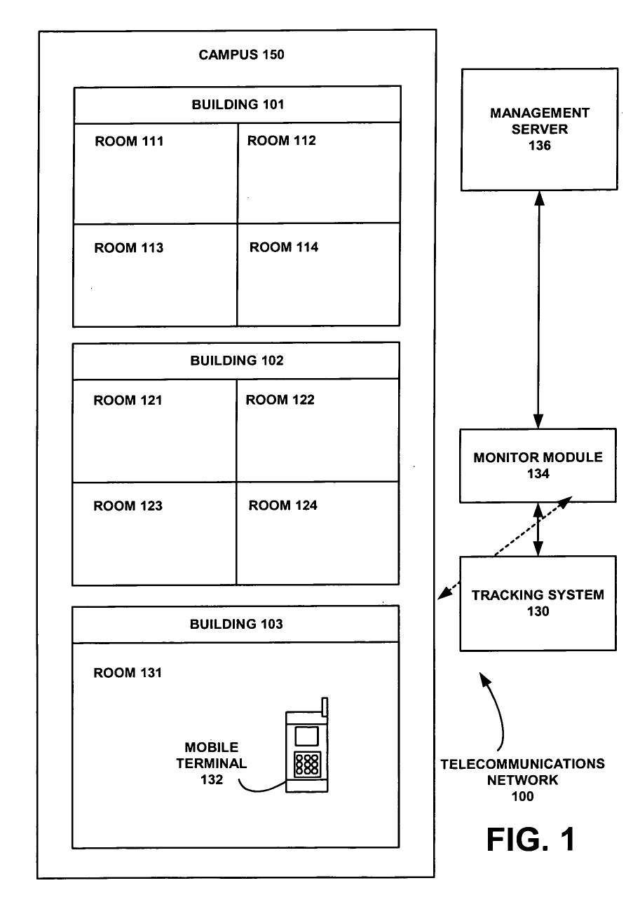

FIG. 1 is a representation of one implementation of an apparatus that automatically notifies the owner of a campus when a mobile terminal is present in an area, such as a building or part of a building.

A telecommunications network 100 may have a tracking system 130 operatively coupled to one or more mobile terminals 132. The network 100 may be, or may be part of, one or more of a telephone network, a local area network (“LAN”), the Internet, and a wireless network. The tracking module 130 detects the current location of the mobile terminal 132 in the campus 150, and forwards the information to a monitor module 134. As described below, the tracking module may be, for example, GPS based or microcell based. The monitor module 134 may be operatively coupled to a management server 136 for the campus 150. The monitor module 134 may perform different functions, such as saving, displaying, and forwarding the information from the tracking system 130.

The mobile terminal 112 may be any one of a number of devices, such as a cell phone, a personal data assistant (PDA), a laptop computer, etc.

In very general terms the embodiment of the present apparatus, depicted in FIG. 1, may have: a plurality of predefined spaces in a predefined three dimensional area; at least one mobile terminal in a wireless telecommunications network; a tracking system structured to track the at least one mobile terminal in the plurality of predefined spaces in the predefined three dimensional area; and a monitor module in the wireless telecommunications network, the monitor module operatively coupled to receive, via the tracking system, a current position of the at least one mobile terminal in the plurality of predefined spaces in the predefined three dimensional area.

The predefined three dimensional area may be a building, and the plurality of predefined spaces may be a plurality of rooms. The predefined three dimensional area may also be a campus, and in this embodiment the plurality of predefined spaces may be a plurality of buildings. In yet another embodiment the predefined three dimensional area may a campus, and the plurality of predefined spaces may be a plurality of rooms in a plurality of buildings. Other embodiments may include caves, underground bunkers, space stations, parking garages, etc.

In the FIG. 1 embodiment the predefined three dimensional area may be a campus 150, and the plurality of predefined spaces may be a plurality of buildings 101, 102, and 103. Building 101 may have rooms 111, 112,113, and 114; building 102 may have rooms 121, 122, 123, and 124. Building 103 may have a single room 131. The mobile terminal 132 may be tracked as it moves throughout the buildings 101, 102, 103 and rooms 111, 112, 113, 114, 121, 122, 123, 124, and 131 of the campus 150.

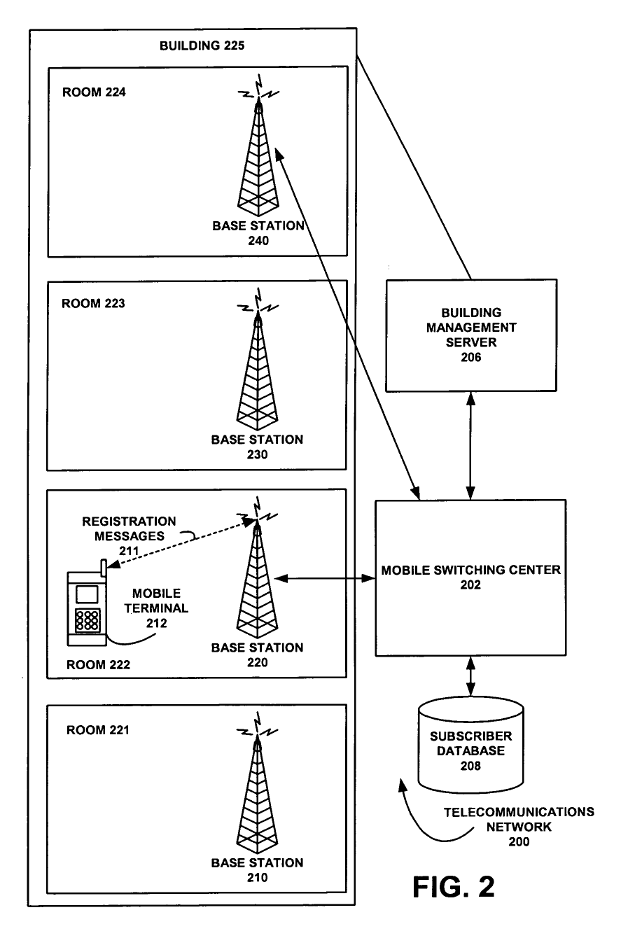

FIG. 2 is a representation of another implementation of an apparatus that automatically notifies the owner of a building when a mobile terminal is present in an area such as a building or part of a building. In this embodiment a telecommunications network 200 may have a mobile switching center 202. The network 200 may be, or may be part of, one or more of a telephone network, a local area network (“LAN”), the Internet, and a wireless network. In the depicted embodiment, calls may be routed to and from a mobile terminal 212 through the mobile switching center 102. The mobile switching center 102 may also be connected to a respective base station. In the FIG. 2 depicted embodiment each room 221, 222, 223, 224 may be microcell having a base station 210, 220, 230, 240. The base station, such as 220, may communicate with the mobile terminal 212 in its service area (microcell 222) using a subscriber database 208.

In general terms the FIG. 2 embodiment of the present apparatus may have: a plurality of predefined spaces 221, 222, 223, 224 in a predefined three dimensional area (building 225); a plurality of microcells in a wireless telecommunications network 200, a respective microcell in the plurality of microcells corresponding to a respective predefined space in the plurality of predefined spaces 221, 222, 223, 224; and a monitor module, such as mobile switching center 202 in the wireless telecommunications network 200.

In a further embodiment of the present apparatus a respective mobile terminal 212 is tracked based on mobile terminal registration messages 211 between the respective mobile terminal 212 and the plurality of microcells in the plurality of predefined spaces 221, 222, 223, 224 in the predefined three dimensional area 225.

In another further embodiment of the present apparatus, the apparatus may have a building management server 206 associated with the three dimensional area (building 225) and operatively coupled to the wireless telecommunications network via the mobile switching center 202.

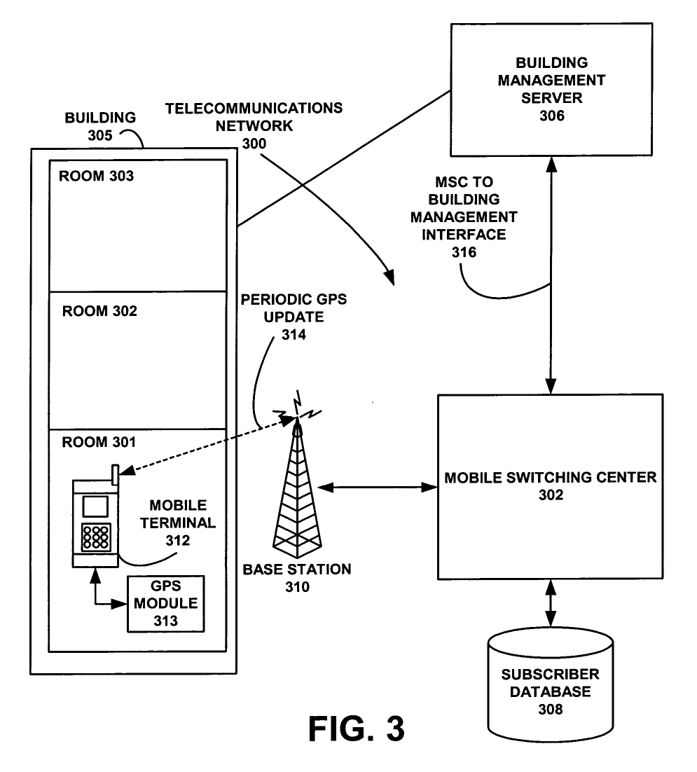

FIG. 3 is a representation of yet another implementation of an apparatus that automatically notifies the owner of a building when a mobile terminal is present in an area such as a building or part of a building. This embodiment of the present apparatus may have: a plurality of predefined spaces (such as rooms 301, 302, 303) in a predefined three dimensional area (such as building 305); at least one mobile terminal 312 having a GPS (Global Positioning System) module 313; a wireless telecommunications network 300 to which is provided, via the GPS module 313, a current position of the at least one mobile terminal 312 in the plurality of predefined spaces 301, 302, 303 in the predefined three dimensional area 305; and a monitor module (such as mobile switching center 302 in the wireless telecommunications network 300, the monitor module 302 operatively coupled to receive the current position of the at least one mobile terminal 312 in the plurality of predefined spaces 301, 302, 303 in the predefined three dimensional area 305.

The mobile switching center 302 may be operatively coupled, via an interface 316 to a building management server 306 that may be associated with the building 305.

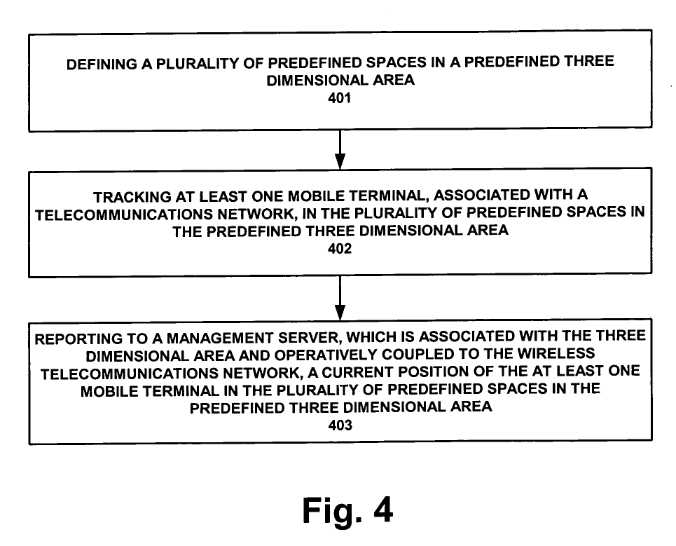

FIG. 4 is a representation of one exemplary flow diagram for automatically notifying the owner of a building when a mobile terminal is present in an area such as a building or part of a building. This embodiment may have the following steps: defining a plurality of predefined spaces in a predefined three dimensional area (401); tracking at least one mobile terminal, associated with a telecommunications network, in the plurality of predefined spaces in the predefined three dimensional area (402); and reporting to a management server, which is associated with the three dimensional area and operatively coupled to the wireless telecommunications network, a current position of the at least one mobile terminal in the plurality of predefined spaces in the predefined three dimensional area (403).

Embodiments of the present apparatus and method overcomes the drawbacks of the prior art by providing a telecommunications network that automatically notifies the owner of a building when a mobile terminal is present in an area such as a building or part of a building.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus (for example 200) may comprise the recordable data storage medium (for example, subscriber database 208). The computer-readable signal-bearing medium may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a plurality of predefined spaces in a predefined three dimensional area;
at least one mobile terminal in a wireless telecommunications network;
a tracking system, in the wireless telecommunications network, structured to track the at least one mobile terminal in the plurality of predefined spaces in the predefined three dimensional area; and
a monitor module in the wireless telecommunications network, the monitor module operatively coupled to receive, via the tracking system, a current position of the at least one mobile terminal in the plurality of predefined spaces in the predefined three dimensional area.

2. The apparatus defined in claim 1, wherein the apparatus further comprises a management server associated with the three dimensional area and operatively coupled to the wireless telecommunications network.

3. The apparatus defined in claim 1, wherein the predefined three dimensional area is a building, and wherein the plurality of predefined spaces are a plurality of rooms.

4. The apparatus defined in claim 1, wherein the predefined three dimensional area is a campus, and wherein the plurality of predefined spaces are a plurality of buildings.

5. The apparatus defined in claim 1, wherein the predefined three dimensional area is a campus, and wherein the plurality of predefined spaces are a plurality of rooms in a plurality of buildings.

6. An apparatus, comprising:
a plurality of predefined spaces in a predefined three dimensional area;
at least one mobile terminal having a GPS (Global Positioning System) module;
a wireless telecommunications network to which is provided, via the GPS module, a periodic current position of the at least one mobile terminal in the plurality of predefined spaces in the predefined three dimensional area; and
a monitor module in the wireless telecommunications network, the monitor module operatively coupled to receive the current position of the at least one mobile terminal in the plurality of predefined spaces in the predefined three dimensional area.

7. The apparatus defined in claim 6, wherein the apparatus further comprises a management server associated with the three dimensional area and operatively coupled to the wireless telecommunications network.

8. The apparatus defined in claim 6, wherein the predefined three dimensional area is a building, and wherein the plurality of predefined spaces are a plurality of rooms.

9. The apparatus defined in claim 6, wherein the predefined three dimensional area is a campus, and wherein the plurality of predefined spaces are a plurality of buildings.

10. The apparatus defined in claim 6, wherein the predefined three dimensional area is a campus, and wherein the plurality of predefined spaces are a plurality of rooms in a plurality of buildings.

11. An apparatus, comprising:
a plurality of predefined spaces in a predefined three dimensional area;
a plurality of microcells in a wireless telecommunications network , a respective microcell in the plurality of microcells corresponding to a respective predefined space in the plurality of predefined spaces; and
a monitor module in the wireless telecommunications network, the monitor module operatively coupled to the plurality of microcells for tracking locations of mobile terminals located in the plurality of predefined spaces.

12. The apparatus defined in claim 11, wherein a respective mobile terminal is tracked based on mobile terminal registration messages between the respective mobile terminal and the plurality of microcells in the plurality of predefined spaces in the predefined three dimensional area.

13. The apparatus defined in claim 11, wherein the apparatus further comprises a management server associated with the three dimensional area and operatively coupled to the wireless telecommunications network.

14. The apparatus defined in claim 11, wherein the predefined three dimensional area is a building, and wherein the plurality of predefined spaces are a plurality of rooms.

15. The apparatus defined in claim 11, wherein the predefined three dimensional area is a campus, and wherein the plurality of predefined spaces are a plurality of buildings.

16. The apparatus defined in claim 11, wherein the predefined three dimensional area is a campus, and wherein the plurality of predefined spaces are a plurality of rooms in a plurality of buildings.

17. A method, comprising:
defining a plurality of predefined spaces in a predefined three dimensional area;
tracking at least one mobile terminal, associated with a telecommunications network, in the plurality of predefined spaces in the predefined three dimensional area; and
reporting to a management server, which is associated with the three dimensional area and operatively coupled to the wireless telecommunications network, a current position of the at least one mobile terminal in the plurality of predefined spaces in the predefined three dimensional area.

18. The method defined in claim 17, wherein the predefined three dimensional area is a building, and wherein the plurality of predefined spaces are a plurality of rooms.

19. The method defined in claim 17, wherein the predefined three dimensional area is a campus, and wherein the plurality of predefined spaces are a plurality of buildings.

20. The method defined in claim 17, wherein the predefined three dimensional area is a campus, and wherein the plurality of predefined spaces are a plurality of rooms in a plurality of buildings.
